(19) United States
(12) Patent Application Publication
(10) Pub. No.: US 2013/0081547 A1
(43) Pub. Date: Apr. 4, 2013

(54) SQUEEZE-TYPE JUICE EXTRACTOR

(71) Applicant: Wei Hu, Cixi (CN)

(72) Inventor: Wei Hu, Cixi (CN)

(21) Appl. No.: 13/333,382

(22) Filed: Dec. 21, 2011

(30) Foreign Application Priority Data
Sep. 30, 2011 (CN) 201110292163.8

(51) Int. Cl. A23N 1/00

(52) U.S. Cl. 99/495

(57) ABSTRACT

A squeeze-type juice extractor includes a base, a squeeze assembly installed on the base, and a feed assembly locked on the squeeze assembly. A drive member is disposed inside the base, a drive shaft is disposed at a top of the base. The drive member drives the drive shaft to rotate. The squeeze assembly includes a glass body, a mesh barrel fixedly installed in the glass body, and a screw rod located in the mesh barrel and connected to the drive shaft. A squeeze space is formed between the mesh barrel and the screw rod. An annular juice collection groove is formed at a bottom of the glass body and in communication with a juice outlet disposed on the glass body. An annular residue collection groove is formed at a bottom of the mesh barrel and in communication with a residue discharge passage disposed on the glass body.

### CROSS-REFERENCE TO RELATED PATENT APPLICATION

This application claims priority to and the benefit of, pursuant to 35 U.S.C. §119(a), Chinese Patent Application No. 201110292163.8, filed Sep. 30, 2011, entitled “SQUEEZE-TYPE JUICE EXTRACTOR”, by Wei H U, the content of which is incorporated herein by reference in its entirety.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The present invention relates generally to a juice extractor, and more particularly to a low-speed squeeze-type juice extractor.

### BACKGROUND OF THE INVENTION

For a healthy life, it becomes more popular to directly make and drink juice, including green juice, at home. Therefore, various devices capable of simply extracting juice from the vegetable or fruits at home have been provided. In an existing juice extractor, the material placed in an inlet port is crushed at a high speed and the juice is produced by using a centrifugal separation method. However, in the high-speed crushing process of the existing juice extractor, the intrinsic flavor and nutrition contained in the fruit are damaged and also it is very difficult to extract green juice from vegetables with branches or leaves. It is also difficult to extract juice from highly-sticky fruits such as the kiwi fruit or strawberry. Therefore, a low-speed squeeze-type juice extractor appears in the prior art. For example, Chinese Patent Application No. 200780001269.X, the publication date of which is Nov. 24, 2010, has disclosed a juice extractor, which includes: a cover, the cover having an inlet port formed at a side at an upper part thereof and a rotating shaft hole formed at a center therein; a casing, installed at a lower part of the cover, and having: a guiding claw, formed at a bottom of the casing; a residue outlet port and a juice outlet port, separately formed at a lower part of the casing; a waterproof cylinder, having through holes and formed at the center of the lower part of the casing; and a pressure discharge passage, formed around a lower part of the waterproof cylinder; a screw rod, the screw rod having: an upper rotating shaft, formed at an upper part of the screw rod to be inserted in the rotating shaft hole in a rotatable manner; a plurality of screw rod threads, formed at an outer surface of the screw rod; an inner ring, formed protruding downwards at a bottom end of the screw rod and having one screw rod gear inserted in the pressure discharge passage in a rotatable manner, in which a lower space for receiving the waterproof cylinder is formed inside the inner ring; and a lower rotating shaft, formed at a center of the lower part of the screw rod and formed with polygonal shaft holes thereon; a mesh tube, the mesh tube having: a mesh structure, formed on an outer wall of the mesh tube to discharge the juice to the juice outlet port; and a plurality of wall blades, formed lengthways at the inner surface of the mesh tube to be inserted inside the guiding claw; a rotating brush, installed between the casing and the mesh tube to rotate and having a brush frame installed with a brush for continuously cleaning the mesh tube and the casing; and a drive unit, the drive unit having a polygonal shaft passing through the through hole of the waterproof cylinder and inserted inside the polygonal shaft hole, and the screw rod rotating at a low speed. The casing for accommodating the screw rod is fixed on the upper side of the drive unit lengthways, so as to crush and grind the material placed in the inlet port and extract the juice and discharge the residue.

Although the above technical solution can implement low-speed pressing for juice extraction, the screw rod in the above solution is required to drive the rotating brush to rotate through a complicated transmission mechanism, so that the structure becomes more complicated and failures occur easily. The moulds for all parts in the above solution are also complicated, the positioning after installation is difficult and the cleaning is inconvenient. In particular, the rotating brush structure requires to be driven by a complicated transmission mechanism, so that the processing becomes more complicated, the installation requirements are high, and the positioning precision needs to be very high.

Therefore, a heretofore unaddressed need exists in the art to address the aforementioned deficiencies and inadequacies.

### SUMMARY OF THE INVENTION

The technical problem to be solved by the present invention is to overcome the defects in the prior art, and provide a low-speed squeeze-type juice extractor with a simple structure and low risks of failures.

In one aspect of the present invention, a squeeze-type juice extractor includes a base in which a drive member is disposed inside the base, a drive shaft is disposed at a top of the base, and the drive member drives the drive shaft to rotate, a squeeze assembly, installed on the base, a feed assembly, locked on the squeeze assembly. The squeeze assembly is formed of a glass body, a mesh barrel fixedly installed in the glass body, and a screw rod located in the mesh barrel. A juice outlet and a residue discharge passage are disposed on the glass body. The screw rod is connected to the drive shaft. A squeeze space is defined between the mesh barrel and the screw rod. An annular juice collection groove is formed at a bottom of the glass body. The annular juice collection groove is in communication with the juice outlet. An annular residue collection groove is formed at a bottom of the mesh barrel. The annular residue collection groove is in communication with the residue discharge passage.

Additionally, the squeeze-type juice extractor further has the following additional technical features in accordance with embodiments of the present invention.

One or more thread squeeze blades are formed on an outer wall of the screw rod. A residue scraping leg is formed at an end portion of each thread squeeze blade extending to a bottom of the screw rod. The residue scraping leg is located in the annular residue collection groove.

A central portion of the bottom of the glass body bulges upwards to form a boss. The annular juice collection groove is formed between a sidewall of the boss and an inner wall of the bottom of the glass body.

A hollow column body is disposed in the middle of the boss. A seal case is disposed at a top of the hollow column body. A transmission shaft of the screw rod passes through the seal case and the hollow column body to be connected to the drive shaft. A hollow-out portion is formed at the bottom of the mesh barrel. A periphery of the hollow-out portion turns upwards to form a flange. The annular residue collection groove is formed between the flange and the inner wall of the mesh barrel. A residue outlet is formed at the bottom of the annular residue collection groove. The residue outlet is inserted at the bottom of the glass body to be in communication with the residue discharge passage.

An inner concave sliding portion is formed at the bottom of the screw rod. The flange is inserted inside the inner concave sliding portion and is supported at the bottom of the inner concave sliding portion.

The juice outlet is located at the bottom of the glass body and disposed inclining downwards.

A residue discharge groove is formed at the top of the base. The residue discharge passage is in communication with the residue discharge groove.

Two pits are formed on the top of the base. The bottoms of the juice outlet and residue discharge passage are respectively clamped in the pits.

A locking rod is disposed on the base. A top end of the locking rod is locked at the top of the feed assembly or the squeeze assembly.

Clamping grooves is formed at two sides of the base. An end of the locking rod is installed in the clamping groove.

A safety switch is disposed inside the base. The feed assembly and the locking rod fit with the safety switch to trigger the safety switch.

A triggering rod is disposed on the glass body. The top end of the triggering rod coordinates with the feed assembly, and a bottom end thereof is held against the safety switch.

A triggering portion is formed at a hinge end of the locking rod. The triggering portion extends inside the base and is held against the safety switch.

The drive member includes a motor and a reduction mechanism connected to the motor. The reduction mechanism is connected to the drive shaft. The drive shaft and the drive member are disposed eccentrically.

An installation support for installing electric components is disposed below the drive shaft.

A positioning groove is disposed at the bottom of the base. The drive member is installed in the positioning groove.

A fixing stand for fixing the drive shaft is disposed on a top of the base. A plurality of fixing columns is disposed inside the base.

A top of the base is a slope. The squeeze assembly is installed on the slope in a tilted manner.

The feed assembly includes a cover body locked on the squeeze assembly, and a feed passage and a material squeezing rod connected to the cover body. A convex portion is disposed on the cover body. A bearing is disposed at the convex portion. The bearing is connected to a top of the transmission shaft of the screw rod.

A residue glass and a juice glass are further included. The residue glass fits with the residue discharge passage. The juice glass fits with the juice outlet. Both the left and right corners of the juice glass are disposed with a spout.

A residue glass and a juice glass are further included. A residue receiving opening is formed at the residue glass. The residue receiving opening extends in the residue discharge groove. The juice glass fits with the juice outlet.

Compared with the prior art, a squeeze-type juice extractor of the present invention has at least the following advantages. First, according to the present invention, the squeeze-type juice extractor does not need the rotating brush, the transmission mechanism for driving the rotating brush, and the transmission gear at the bottom of the screw rod that are required in the prior art, so that the structure of the squeeze-type juice extractor is much simpler, the failure rate in manufacture is reduced, the use life is increased, the operation becomes more stable, and the cleaning becomes more convenient. Next, as in the present invention the transmission mechanism does not require to be disposed at the bottom of the glass body, an annular juice collection groove may be disposed at the bottom of the glass body for collecting juice more easily and preventing the juice from splashing. Meanwhile, an annular residue discharge groove may also be disposed at the bottom of the mesh barrel, so the residue discharge becomes much easier. Next, the natural design of the juice discharge and residue discharge passages convex downwards between the glass body and the base are utilized for positioning, so that the positioning is more convenient, the structure is simple, and the cleaning is convenient. The tilted design at the bottom of the glass body makes the discharge of residue and juice smoother and also facilitates the positioning.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a front view of a squeeze-type juice extractor according to one embodiment of the present invention;

FIG. 2 is a three-dimensional view of the squeeze-type juice extractor shown in FIG. 1;

FIG. 3 is a sectional view of the squeeze-type juice extractor shown in FIG. 1;

FIG. 4 is a three-dimensional exploded view of the squeeze-type juice extractor shown in FIG. 1;

FIG. 5 is another sectional view of the squeeze-type juice extractor shown in FIG. 1;

FIG. 6 is yet another sectional view of the squeeze-type juice extractor shown in FIG. 1;

FIG. 7 is a three-dimensional view of a base according to one embodiment of the present invention;

FIG. 8 is a three-dimensional view of a squeeze assembly according to one embodiment of the present invention;

FIG. 9 is another three-dimensional view of the squeeze assembly according to one embodiment of the present invention;

FIG. 10 is a front view of a screw rod according to one embodiment of the present invention;

FIG. 11 is a three-dimensional view of the screw rod shown in FIG. 10;

FIG. 12 is a bottom view of the screw rod shown in FIG. 10;

FIG. 13 is a sectional view of the screw rod shown in FIG. 10;

FIG. 14 is a three-dimensional view of a glass body according to one embodiment of the present invention;

FIG. 15 is a three-dimensional view of the glass body according to another embodiment of the present invention;

FIG. 16 is a sectional view of a glass body according to one embodiment of the present invention;

FIG. 17 is another sectional view of a glass body according to one embodiment of the present invention;

FIG. 18 is a further sectional view of a glass body according to one embodiment of the present invention;

FIG. 19 is a front view of a mesh barrel according to one embodiment of the present invention;

FIG. 20 is a top view of the mesh barrel shown in FIG. 19;

FIG. 21 is a three-dimensional view of the mesh barrel shown in FIG. 19;

FIG. 22 is a sectional view of the mesh barrel shown in FIG. 19;

FIG. 23 is a partially sectional view of a squeeze-type juice extractor when a glass body, a mesh barrel, and a screw rod are installed together according to one embodiment of the present invention;

FIG. 24 is a front view of a base according to one embodiment of the present invention;

FIG. 25 is a three-dimensional view of the base shown in FIG. 24;

FIG. 26 is a sectional view of the base shown in FIG. 24;

FIG. 27 is a three-dimensional view of a bottom of a base according to one embodiment of the present invention;

FIG. 28 is a front view of a drive member according to one embodiment of the present invention;

FIG. 29 is a three-dimensional view of the drive member shown in FIG. 28;

FIG. 30 is a front view of a feed assembly according to one embodiment of the present invention;

FIG. 31 is a three-dimensional view of the feed assembly shown in FIG. 30;

FIG. 32 is a sectional view of the feed assembly shown in FIG. 30;

FIG. 33 is a three-dimensional view of a residue glass according to one embodiment of the present invention;

FIG. 34 is a three-dimensional view of a juice glass according to one embodiment of the present invention; and

FIG. 35 is a three-dimensional view of another embodiment of one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

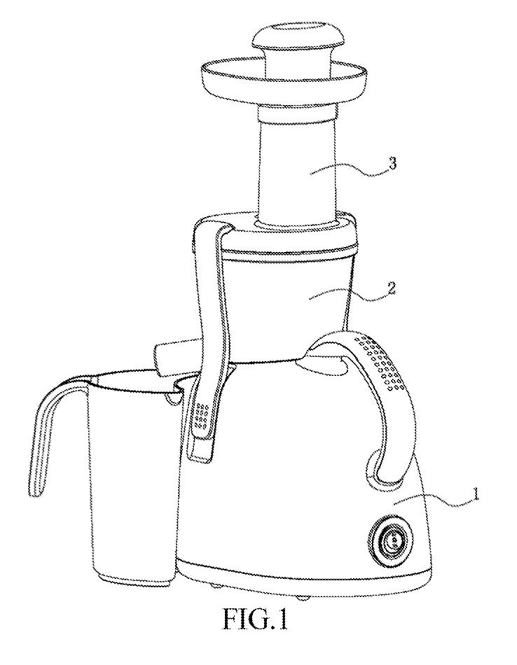

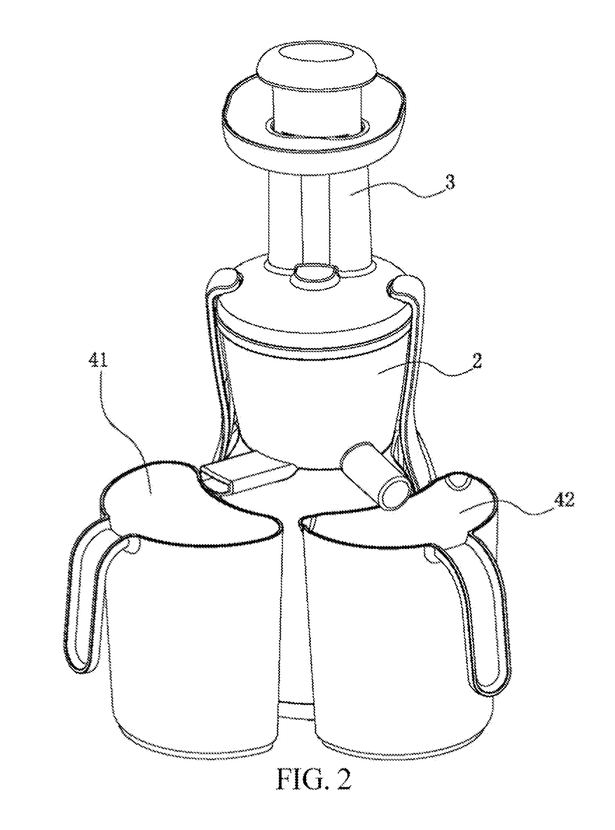

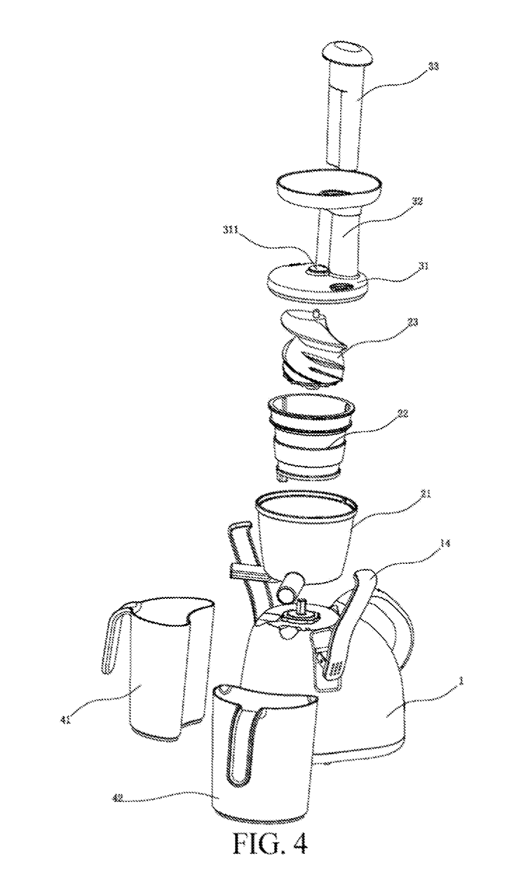

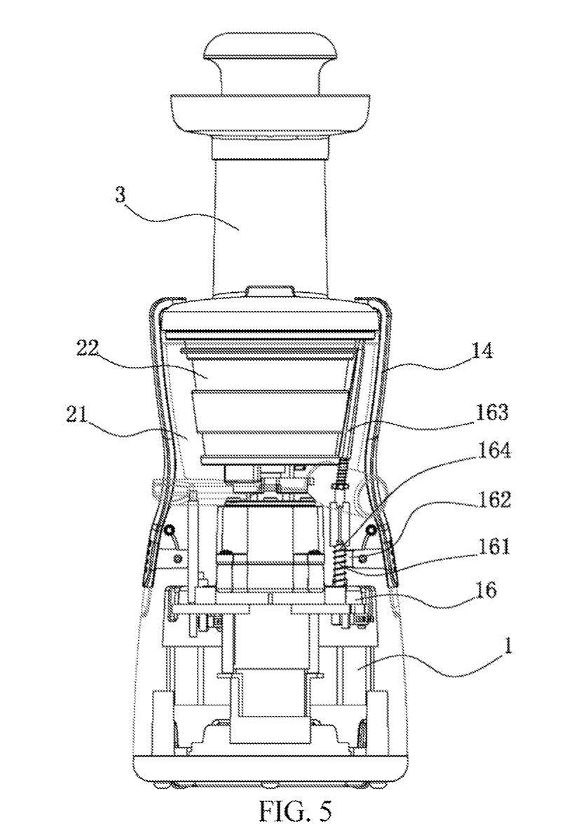

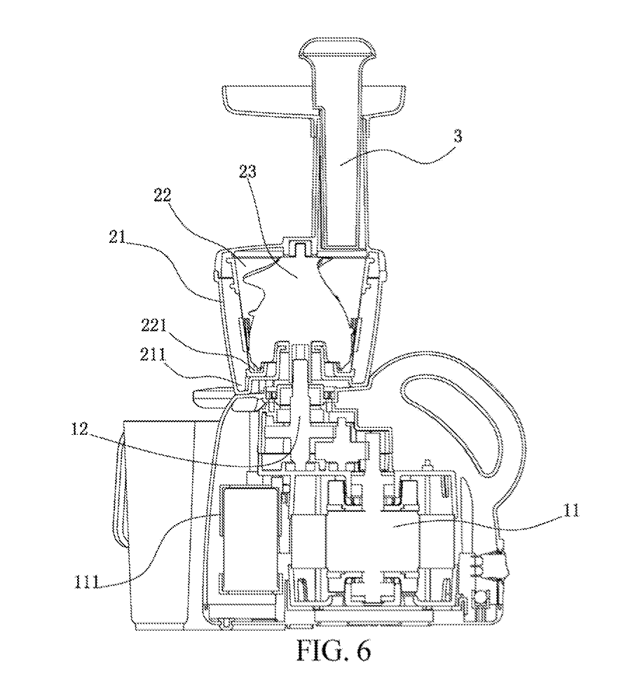

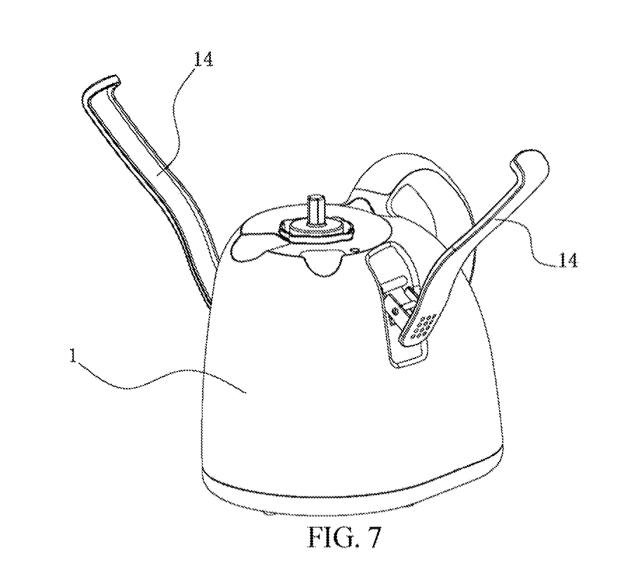

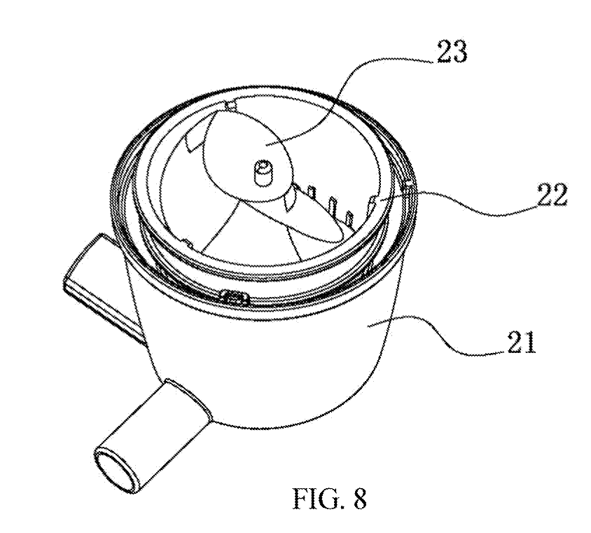

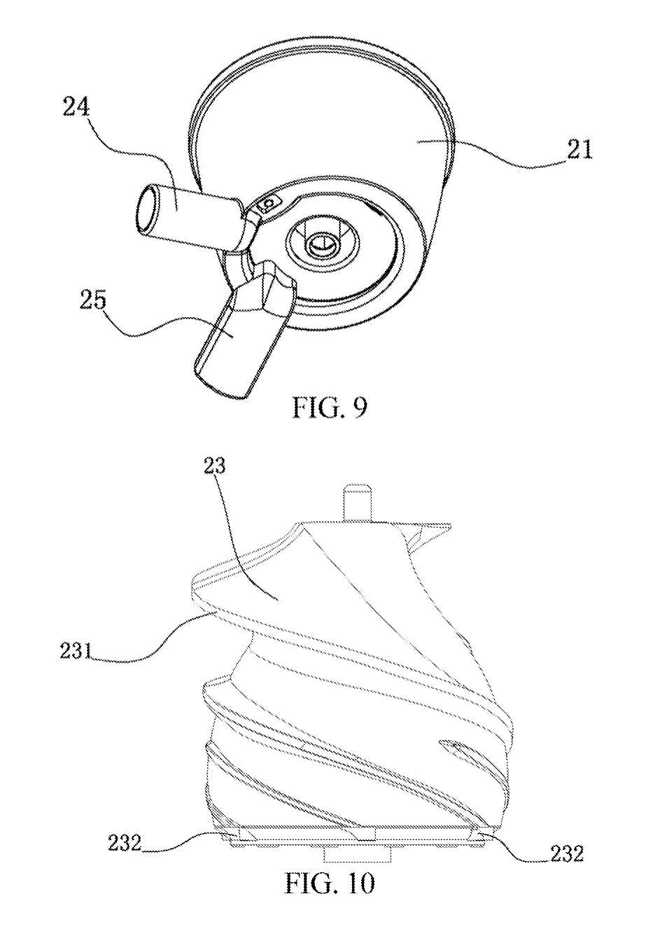

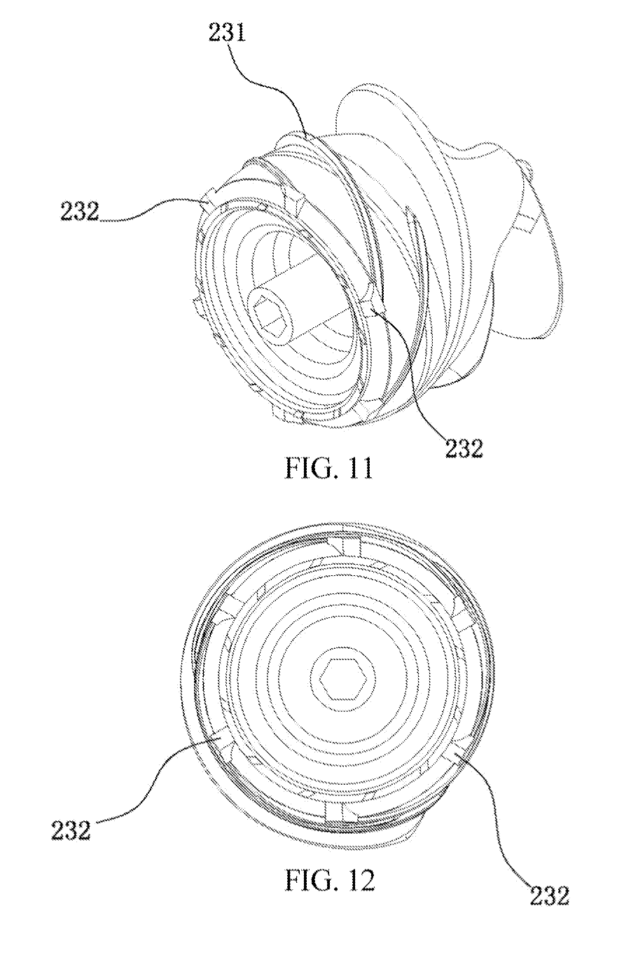

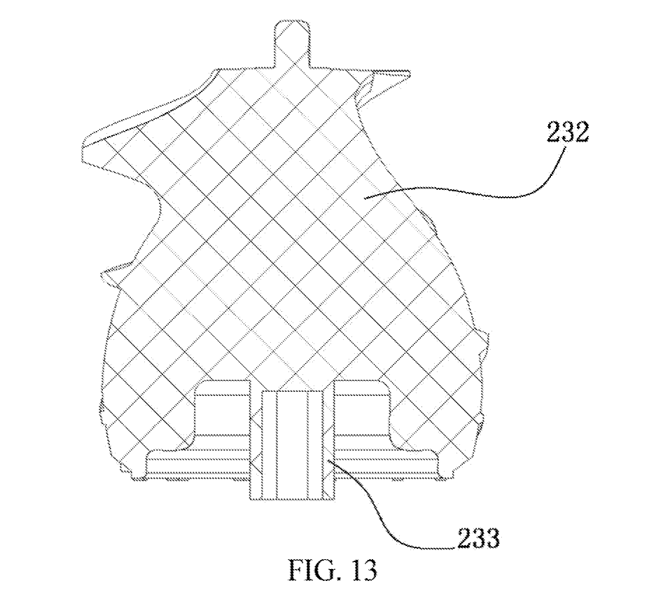

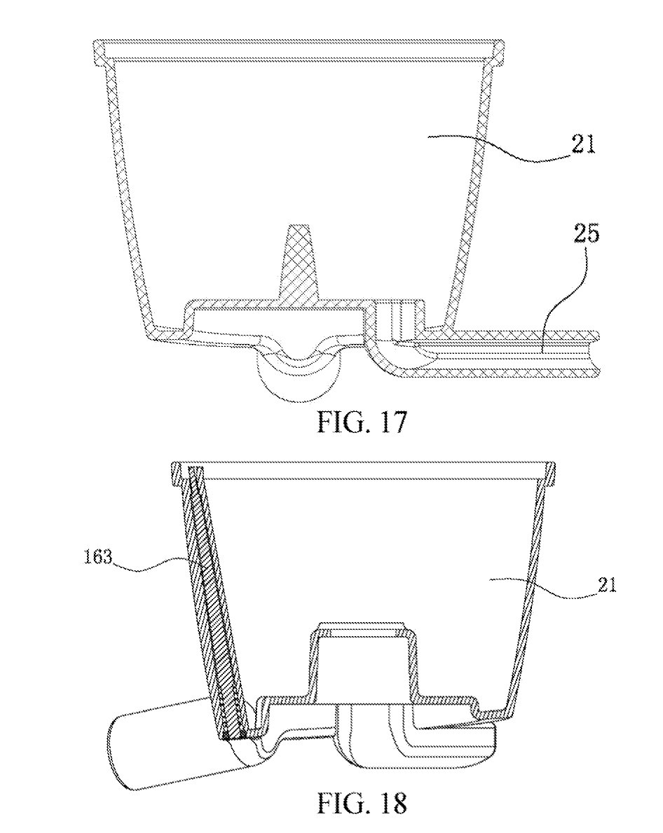

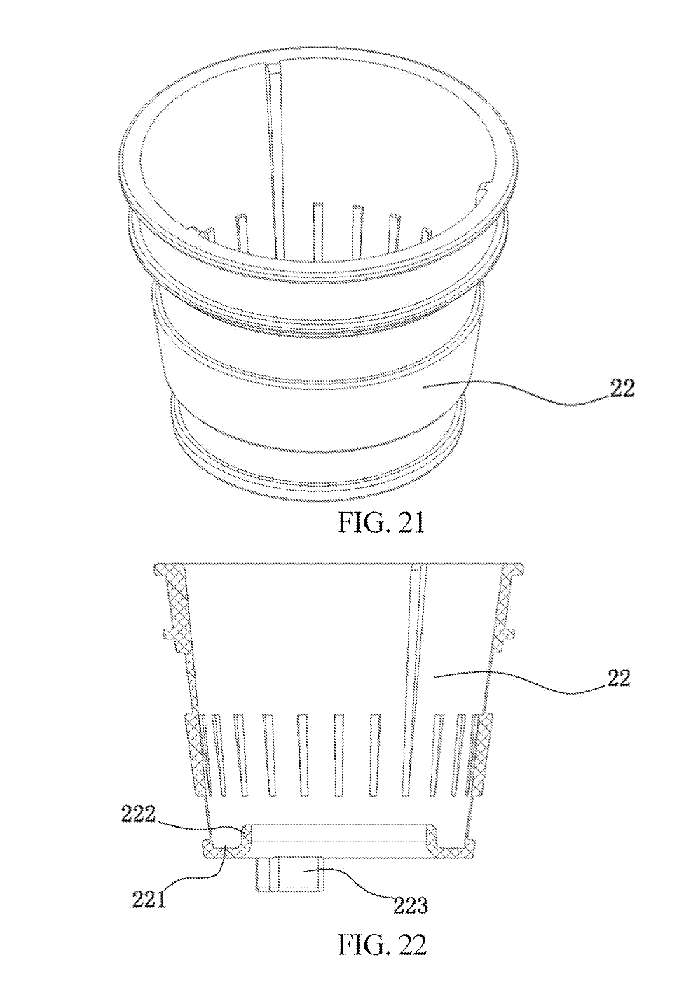

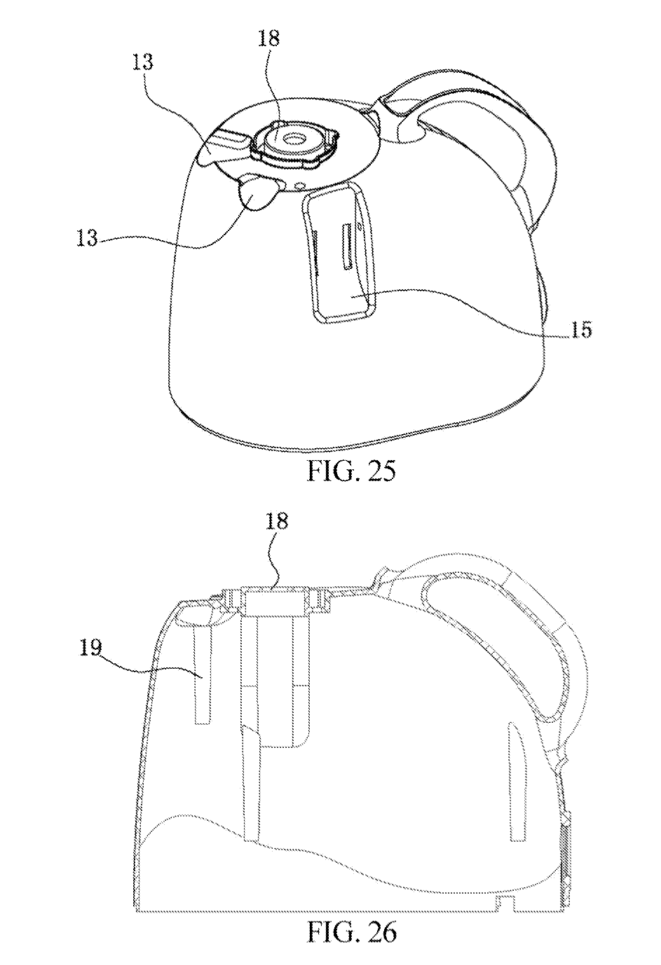

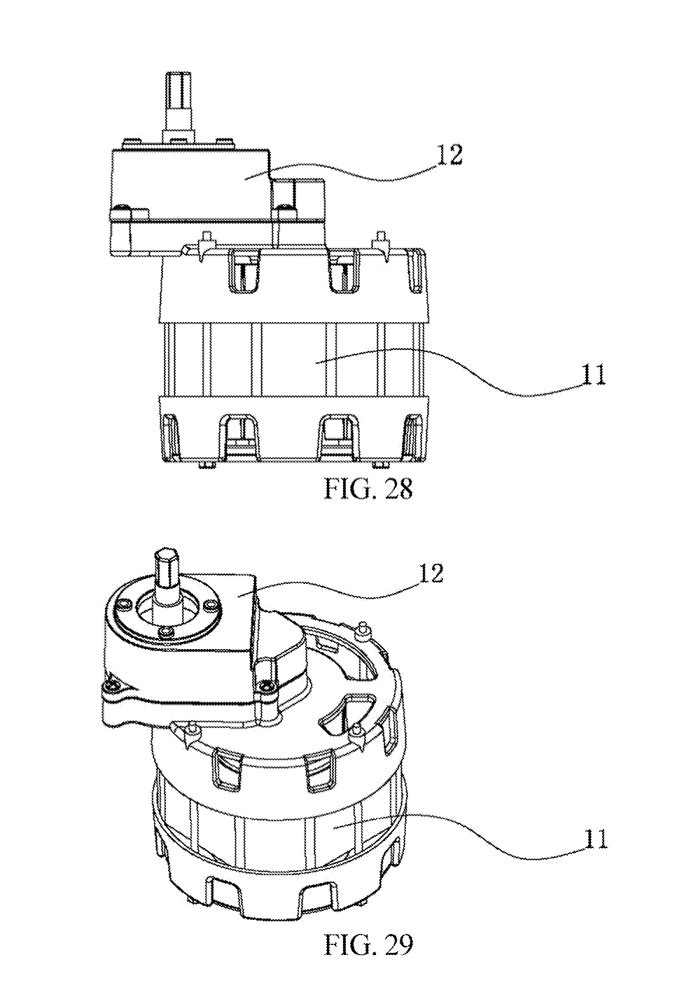

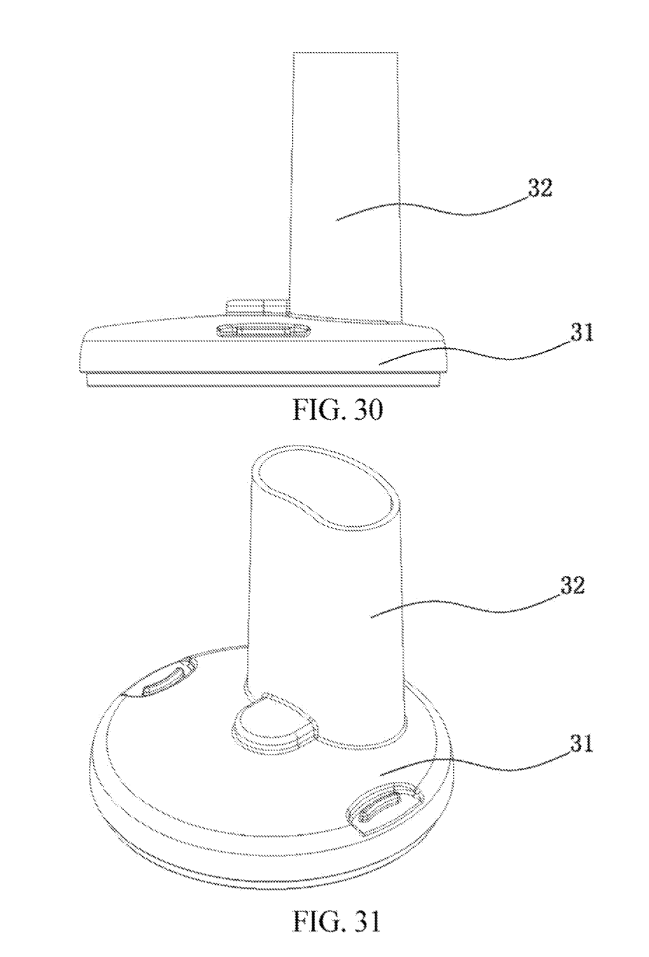

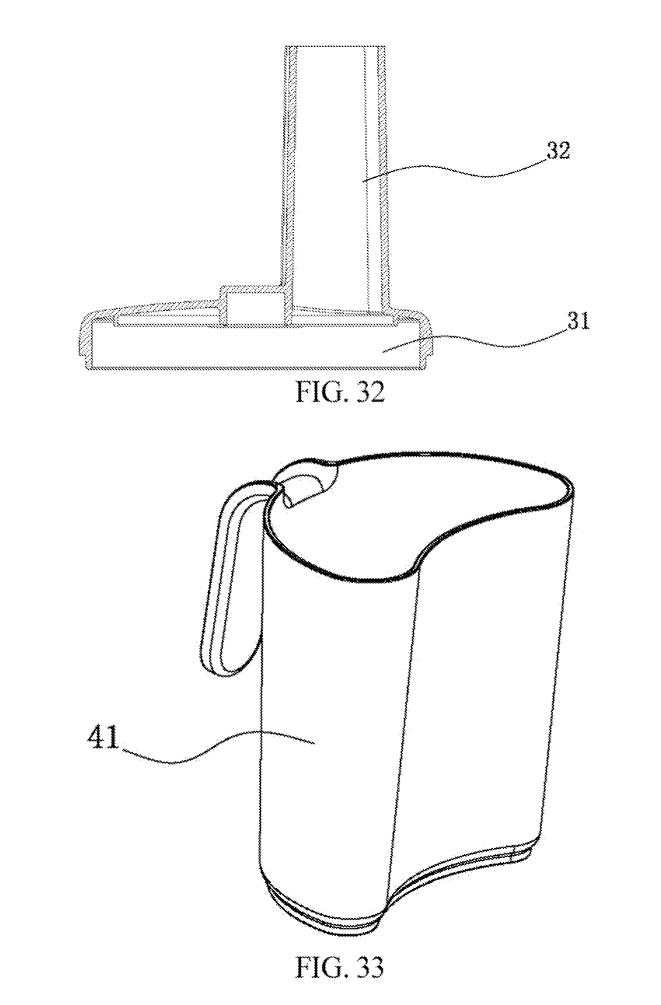

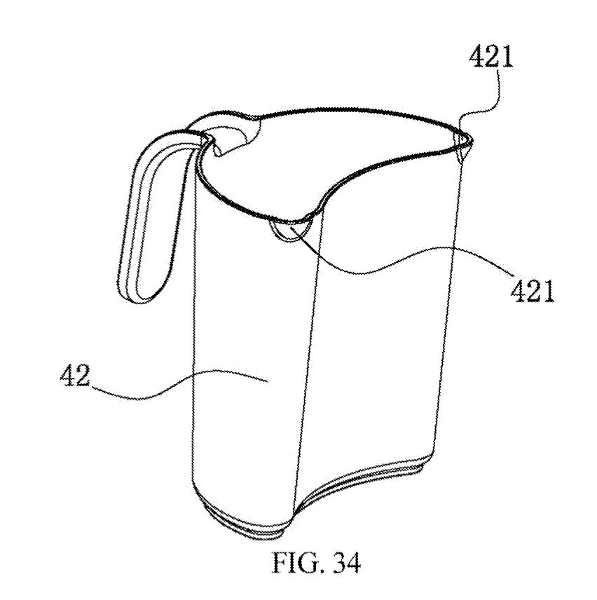

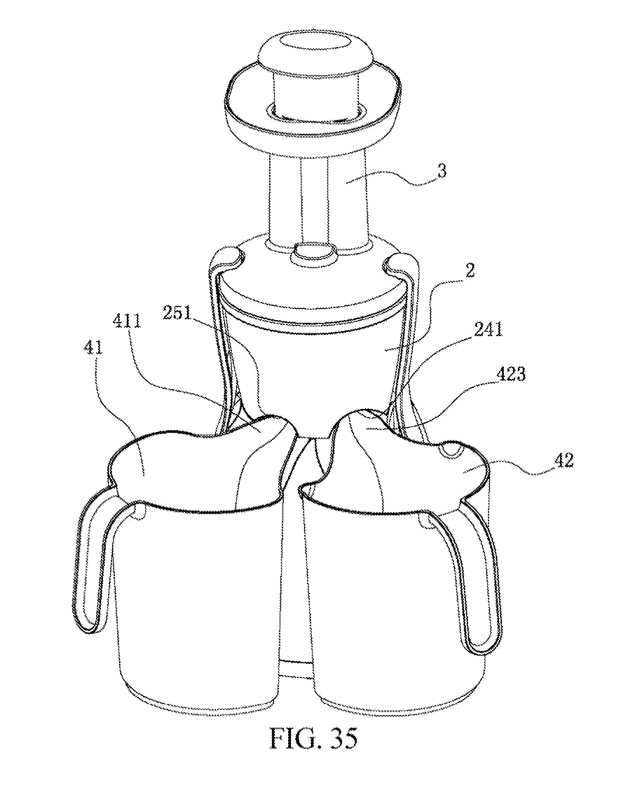

The description will be made as to the embodiments of the present invention in conjunction with the accompanying drawings in FIGS. 1-35. In accordance with the purposes of this invention, as embodied and broadly described herein, this invention, in one aspect, relates to a squeeze-type juice extractor.

Referring to FIG. 1 to FIG. 6, a squeeze-type juice extractor in an embodiment of the present invention includes a base 1, a squeeze assembly 2, and a feed assembly 3. A drive member 11 is formed at the base 1. A drive shaft 12 is disposed on a top of the base 1. The drive member 11 drives the drive shaft 12 to rotate. The squeeze assembly 2 is installed on the base 1. The feed assembly 3 is locked on the squeeze assembly 2.

Referring to FIGS. 1-6, and 8-23, the squeeze assembly 2 includes a glass body 21, a mesh barrel 22 fixedly installed in the glass body 21, and a screw rod 23 located in the mesh barrel 22. A juice outlet 24 and a residue discharge passage 25 are disposed on the glass body 21. The screw rod 23 is connected to the drive shaft 12. A squeeze space is formed between the mesh barrel 22 and the screw rod 23. An annular juice collection groove 211 is formed at the bottom of the glass body 21. The annular juice collection groove 211 is in communication with the juice outlet 24. An annular residue collection groove 221 is formed at the bottom of the mesh barrel 22. The annular residue collection groove 221 is in communication with the residue discharge passage 25.

The present invention removes the rotating brush outside the mesh barrel 22 to achieve the same juice extraction effect. The rotating brush is removed, the transmission gear at the bottom of the screw rod 23 is removed, and the gear in the glass body 21 is also removed. After these structures are removed, the annular juice collection groove 211 is disposed at the bottom of the glass body 21 in the present invention, and the sidewall of the annular juice collection groove 211 forms an enclosed structure, such that the juice can be better collected and discharged. The screw rod 23 of the present invention can be better installed in the mesh barrel 22, and the operation is more stable. Therefore, the structure of the present invention is simpler, and has a low cost. Also, the structure makes the cleaning more convenient.

Referring to FIGS. 10-13, in the above embodiment of the present invention, one or more thread squeeze blades 231 are formed on an outer wall of the screw rod 23. A residue scraping leg 232 is formed at an end portion of each thread squeeze blade 231 extending to the bottom of the screw rod 23. The residue scraping leg 232 is located in the annular residue collection groove 221. In the present invention, the residue scraping leg 232 is disposed at the bottom of the screw rod 23. The residue scraping leg 232 can push the residue in the annular residue collection groove 221 into the residue discharge passage 25, so the residue discharge becomes smoother. The residue scraping leg 232 is disposed at the root portion of the thread squeeze blade 231, so as to push the residue better.

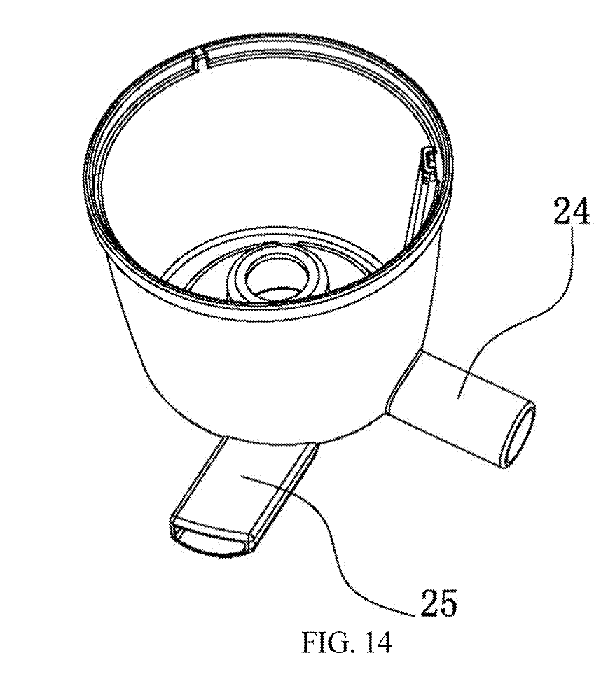

Referring to FIGS. 14-17, in the above embodiment of the present invention, the central portion of the bottom of the glass body 21 bulges upwards to form a boss 212, and the annular juice collection groove 211 is formed between a sidewall of the boss 212 and an inner wall of the bottom of the glass body 21. The bottom of the glass body 21 of the present invention can bulge to form a structure of the boss 212, so that the bottom of the glass body 21 becomes more even, so as to facilitate the juice collection and also enhance the overall strength.

Referring to FIGS. 14-17, in the above embodiment of the present invention, a hollow column body 213 is disposed in the middle of the boss 212. A seal case 214 is disposed on the top of the hollow column body 213. The transmission shaft 233 of the screw rod 23 passes through the seal case 214 and the hollow column body 213 to be connected to the drive shaft 12. The above structure of the present invention can facilitate the connection between the screw rod 23 and the drive shaft 12 and preventing the juice from flowing out. The seal case 214 is a seal piece made of rubber and may of course be seal pieces made of other materials.

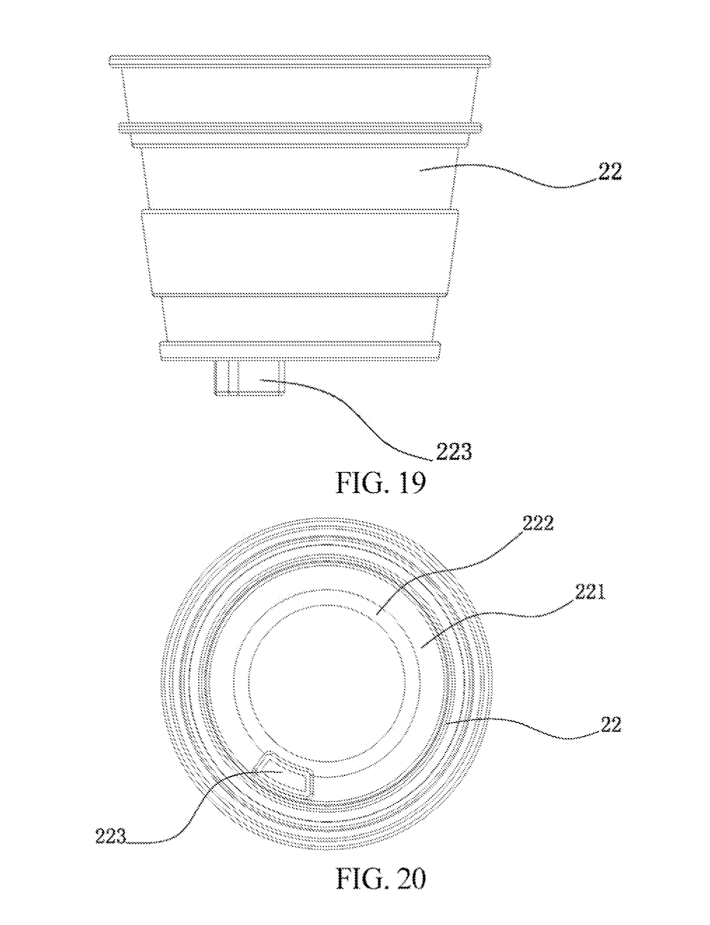

Referring to FIGS. 19-22, in the above embodiment of the present invention, a hollow-out portion is formed at the bottom of the mesh barrel 22. The periphery of the hollow-out portion turns upwards to form a flange 222. The annular residue collection groove 221 is formed between the flange 222 and the inner wall of the mesh barrel 22. A residue outlet 223 is formed at the bottom of the annular residue collection groove 221. The residue outlet 223 is inserted at the bottom of the glass body 21 to be in communication with the residue discharge passage 25. The residue outlet 223 in the present invention is inserted at the bottom of the glass body 21, not only the communication effect is achieved, but also the mesh barrel 22 is fixedly installed in the glass body 21, so no rotation occurs. The mesh barrel 22 is made of a case body and a mesh. The mesh is fixed on the case body. The inner wall has convex edges to increase the friction. The principle of the juice extraction of the mesh barrel 22 and the screw rod 23 is the same as that in the prior art. The structure of the annular residue collection groove 221 in the present invention is more proper and the residue discharge becomes smoother.

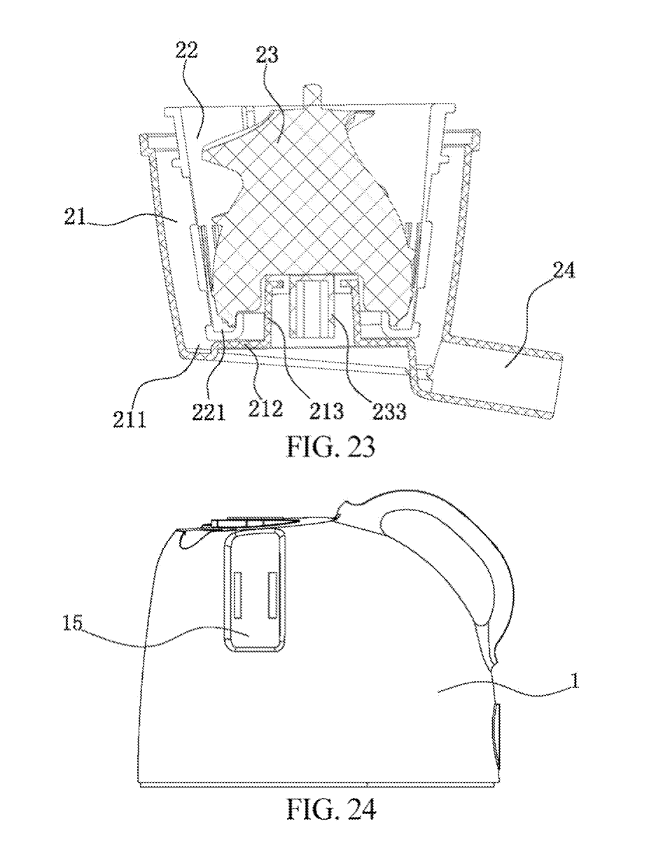

Referring to FIG. 23, in the above embodiment of the present invention, an inner concave sliding portion 233 is formed at the bottom of the screw rod 23. The flange 222 is inserted in the inner concave sliding portion 233 and supported at the bottom of the inner concave sliding portion 233. The screw rod 23 of the present invention is installed in the mesh barrel 22 through the above structure, so the rotation is more stable, the installation becomes more convenient, and the cleaning becomes easy.

Referring to FIGS. 1, 7, 16, 17 and 25, in the above embodiment of the present invention, the juice outlet 24 is located at the bottom of the glass body 21 and disposed inclining downwards. The tilted disposition of the juice outlet 24 makes the juice discharge smoother. Referring to FIGS. 18-20 and 25, two pits 13 are formed on the top of the base 1. The bottoms of the juice outlet 24 and the residue discharge passage 25 are respectively clamped in the pits 13. Through the structure that the juice outlet 24 and the residue discharge passage 25 fit with the pits 13, the squeeze assembly 2 can be better positioned on the base 1 and no other additional positioning mechanisms need to be disposed.

Referring to FIGS. 1, 2, 4, 5 and 7, in the above embodiment of the present invention, locking rods 14 are disposed at two sides of the base 1. A top end of the locking rod 14 is locked at the top of the feed assembly 3 or the squeeze assembly 2, and in this embodiment, locked at the top of the feed assembly 3. Clamping grooves 15 are formed at two sides of the base 1. An end of the locking rod 14 is installed in the clamping groove 15. In the present invention, the squeeze assembly 2 is fixed on the base 1 through the locking rod 14, and during disassembly, only the locking rod 14 needs to be moved, and the above structure is fixed more stably and the disassembly is more convenient.

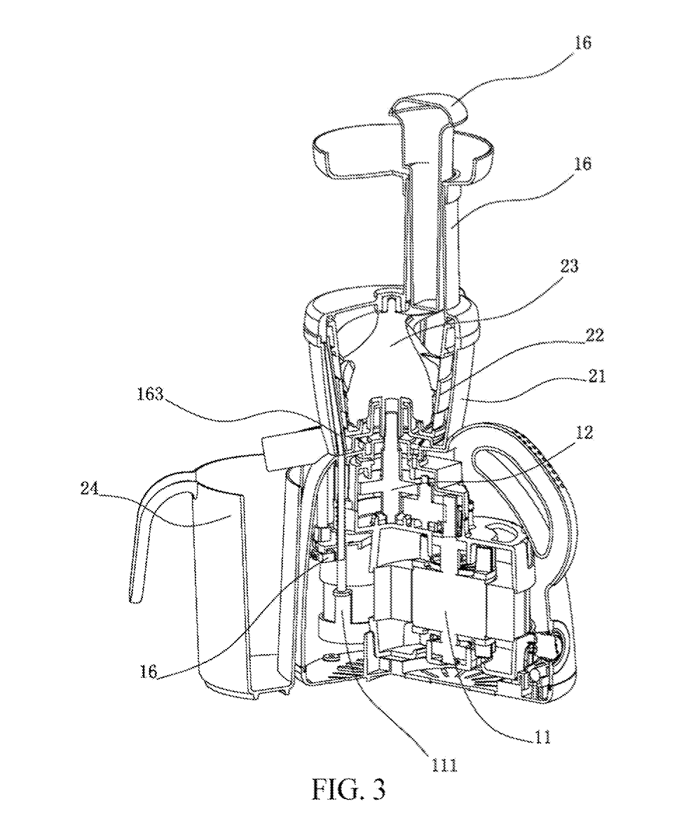

Referring to FIGS. 3, 5 and 18, in the above embodiment of the present invention, a safety switch 16 is disposed inside the base 1. The feed assembly 3 and the locking rod 14 fit with the safety switch 16 to trigger the safety switch 16. A triggering rod 163 is disposed on the glass body 21. The top end of the triggering rod 163 fits with the feed assembly 3, and the bottom end thereof is held against the safety switch 16. The safety switch 16 is installed inside the base 1. Through the top of the connecting rod 164 extending out of the base 1, the triggering rod 163 and the connecting rod 164 are connected. A triggering portion 141 is formed at a hinge end of the locking rod 14. The triggering portion 141 extends inside the base 1 and is held against the safety switch 16. After the hinge end the locking rod 14 is locked, the triggering portion 141 extends into the base 1 and contacts the safety switch 16. After all the parts of the product are assembled, the locking rod 14 is pulled down (the whole feed device 2 and the whole squeeze component and the machine body are integrally connected), when being fully pulled down, the locking rod 14 presses the inside of the machine as the hinge on the machine rotates. The locking rod 14 then presses the stop plate 162 of the safety switch, such that the stop plate 162 of the safety switch triggers the safety switch 16. After all the parts of the product are assembled, the locking rod 14 is locked on the feed assembly 3 and pressed downwards, the feed assembly 3 presses the triggering rod 163 to move downwards. When the triggering rod 163 moves downwards, the connecting rod 161 of the safety switch 16 is pressed to move downwards. Meanwhile, when being fully pulled down, the locking rod 14 presses the inside of the machine as the hinge rotates, and the locking rod 14 presses the connecting rod 161 of the safety switch, the connecting rod 161 triggers the safety switch (when the connecting rod does not fully move downwards, the locking rod 14 fails to presses the connecting rod, and at the same time the safety switch 16 is not touched). Therefore, only when all the above members are successfully installed, the safety switch 16 is triggered and the machine is started, so that the safety is enhanced.

Referring to FIGS. 3, 6, 28 and 29, in the above embodiment of the present invention, the drive member 11 includes a motor and a reduction mechanism (not shown) connected to the motor. The reduction mechanism is connected to the drive shaft 12. The drive shaft 12 and the drive member 11 are eccentrically disposed. An installation support 111 for installing electric components is disposed below the drive shaft. The motor and the reduction mechanism of the present invention may adopt relatively mature structures in the prior art. For example, a gear reduction mechanism or a turbine worm reduction mechanism. In the present invention, the drive shaft 12 and the drive member 11 are eccentrically disposed, so the height can be reduced in the present invention. The electric components are installed on the installation support 111, for example, a large capacity capacitor is installed on the installation support, which is disposed below the drive shaft. Such a structure is simple, the installation is more convenient, and the space is effectively utilized.

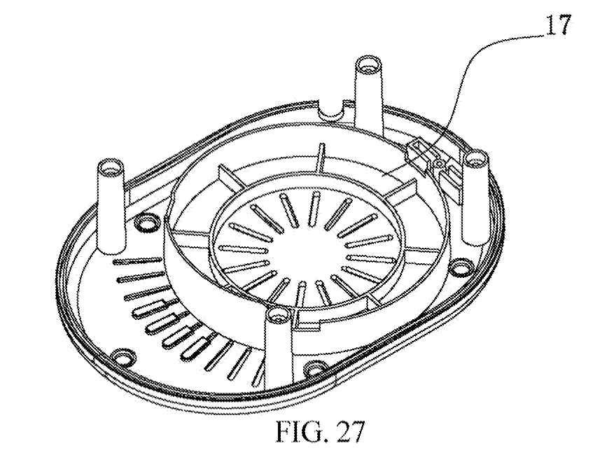

Referring to FIG. 27, in the above embodiment of the present invention, a positioning groove 17 is disposed at the bottom of the base 1. The drive member 11 is installed in the positioning groove 17. The positioning groove 17 facilitates the installation positioning of the drive member 11 such that the installation becomes more convenient.

Referring to FIGS. 24-26, in the above embodiment of the present invention, a fixing stand 18 for fixing the drive shaft 12 is disposed at the top of the base 1. A plurality of fixing columns 19 is disposed inside the base 1. The drive shaft 12 is fixed below the fixing stand 18 through bolts and the fixing columns 19 have a position limiting function.

Referring to FIG. 24, in the above embodiment of the present invention, the top of the base 1 is a slope, and the squeeze assembly 2 is installed on the slope in a tilted manner. The tilted disposition of the squeeze assembly 2 further facilitates the discharge of the juice and residue.

Referring to FIGS. 1-4 and 30-32, in the above embodiment of the present invention, the feed assembly 3 includes a cover body 31 locked on the squeeze assembly 2, a feed passage 32 connected to the cover body 31, and a material squeezing rod 33. A convex portion 311 is disposed on the cover body 31. A bearing is disposed in the convex portion 311. The bearing is connected to a top of the transmission shaft of the screw rod 23. By adopting the structure, the positioning strength is better, so the transmission shaft of the screw rod 23 can be better fixed, and the operation of the screw rod 23 is more stable.

Referring to FIGS. 1-4, 33 and 35, in the above embodiment of the present invention, a residue glass 41 and a juice glass 42 are further included. The residue glass 41 fits with the residue discharge passage 25. The juice glass 42 fits with the juice outlet 24. Both the left and right corners of the juice glass 42 are disposed with a spout 421. The residue glass 41 is located below the residue discharge passage 25. The juice glass 42 is located below the juice outlet 24. Both the left and right corners of the juice glass 42 are disposed with a spout 421 for ease of use by left and right hands.

Referring to FIG. 35, for the residue discharge structure in the present invention, a residue discharge groove 251 may be further formed on the top of the base 1. The residue discharge passage 25 is in communication with the residue discharge groove 251. A residue receiving opening 411 is formed on the residue glass 41. The residue receiving opening 411 extends into the residue discharge groove 251, so as to receive the residue. A juice discharge groove 241 may also be formed at the top of the base 1. The juice outlet 24 is in communication with the juice discharge groove 241. A juice receiving opening 423 is formed on the juice glass 42. The juice receiving opening 423 extends in the juice discharge groove 241, so as to receive the juice. In such a structure, the juice outlet and the residue discharge passage may be disposed relatively short, so as to facilitate the processing of the glass body.

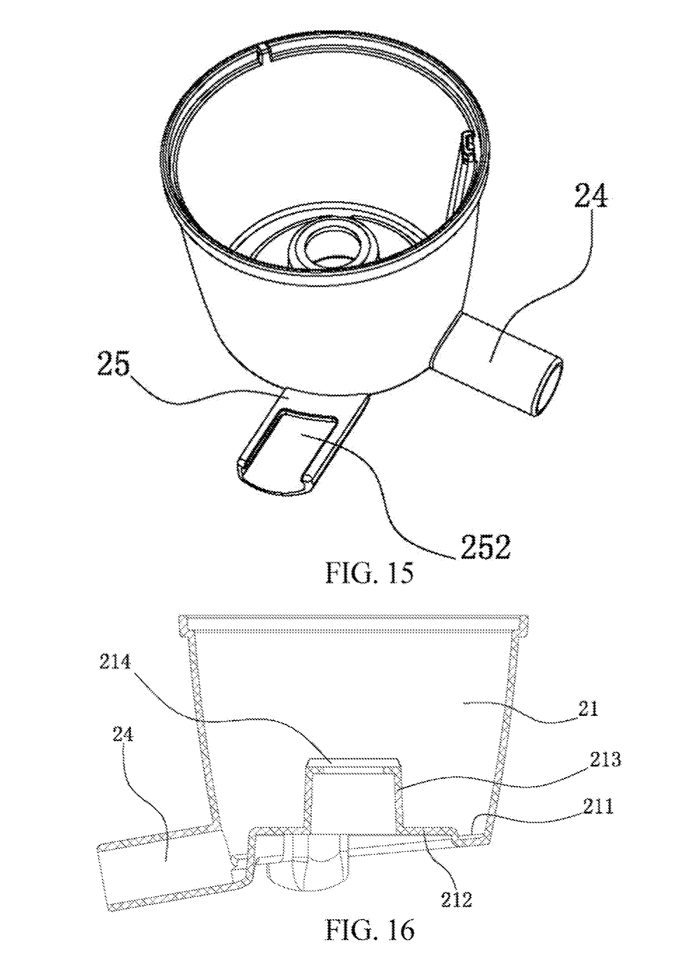

Referring to FIG. 15, the residue discharge passage 25 in the present invention may also be a slot type structure, that is, a partial top slot 252 which is exposed, so as to facilitate the residue discharge.

While there has been shown several and alternate embodiments of the present invention, it is to be understood that certain changes can be made as would be known to one skilled in the art without departing from the underlying scope of the present invention as is discussed and set forth above and below including claims. Furthermore, the embodiments described above and claims set forth below are only intended to illustrate the principles of the present invention and are not intended to limit the scope of the present invention to the disclosed elements.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A squeeze-type juice extractor, comprising:
(a) a base, wherein a drive member is disposed inside the base, a drive shaft is disposed at a top of the base, and the drive member drives the drive shaft to rotate;
(b) a squeeze assembly installed on the base; and
(c) a feed assembly locked on the squeeze assembly;
wherein the squeeze assembly is formed of a glass body, a mesh barrel fixedly installed in the glass body, and a screw rod located in the mesh barrel, a juice outlet and a residue discharge passage are disposed on the glass body, the screw rod is connected to the drive shaft, a squeeze space is formed between the mesh barrel and the screw rod, an annular juice collection groove is formed at a bottom of the glass body, the annular juice collection groove is in communication with the juice outlet, an annular residue collection groove is formed at a bottom of the mesh barrel, and the annular residue collection groove is in communication with the residue discharge passage.

2. The squeeze-type juice extractor according to claim 1, wherein one or more thread squeeze blades are formed on an outer wall of the screw rod, a residue scraping leg is formed at an end portion of each thread squeeze blade extending to a bottom of the screw rod, and the residue scraping leg is located in the annular residue collection groove.

3. The squeeze-type juice extractor according to claim 1, wherein a central portion of the bottom of the glass body bulges upwards to form a boss, and the annular juice collection groove is formed between a sidewall of the boss and an inner wall of the bottom of the glass body.

4. The squeeze-type juice extractor according to claim 3, wherein a hollow column body is disposed in the middle of the boss, a seal case is disposed at a top of the hollow column body, and a transmission shaft of the screw rod passes through the seal case and the hollow column body to be connected to the drive shaft.

5. The squeeze-type juice extractor according to claim 1, wherein a hollow-out portion is formed at the bottom of the mesh barrel, a periphery of the hollow-out portion turns upwards to form a flange, the annular residue collection groove is formed between the flange and an inner wall of the mesh barrel, a residue outlet is formed at a bottom of the annular residue collection groove, and the residue outlet is inserted at the bottom of the glass body and is in communication with the residue discharge passage.

6. The squeeze-type juice extractor according to claim 5, wherein an inner concave sliding portion is formed at a bottom of the screw rod, the flange is inserted in the inner concave sliding portion and is supported at a bottom of the inner concave sliding portion.

7. The squeeze-type juice extractor according to claim 1, wherein the juice outlet is located at the bottom of the glass body and disposed inclining downwards.

8. The squeeze-type juice extractor according to claim 1, wherein a residue discharge groove is formed at the top of the base, and the residue discharge passage is in communication with the residue discharge groove.

9. The squeeze-type juice extractor according to claim 8, further comprising a residue glass and a juice glass, wherein a residue receiving opening is formed on the residue glass, the residue receiving opening is inserted in the residue discharge groove, and the juice glass fits with the juice outlet.

10. The squeeze-type juice extractor according to claim 1, wherein two pits are formed at the top of the base, and bottoms of the juice outlet and the residue discharge passage are respectively clamped in the pits.

11. The squeeze-type juice extractor according to claim 1, wherein a locking rod is disposed on the base, and a top end of the locking rod is locked at a top of the feed assembly or squeeze assembly.

12. The squeeze-type juice extractor according to claim 11, wherein clamping grooves are formed at two sides of the base, and an end of the locking rod is installed in the clamping groove.

13. The squeeze-type juice extractor according to claim 11, wherein a safety switch is disposed inside the base, and the feed assembly and the locking rod fit with the safety switch to trigger the safety switch.

14. The squeeze-type juice extractor according to claim 13, wherein a triggering rod is disposed on the glass body, a top end of the triggering rod fits with the feed assembly, and a lower end thereof is held against the safety switch.

15. The squeeze-type juice extractor according to claim 13, wherein a triggering portion is formed at a hinge end of the locking rod, and the triggering portion extends into the base and is held against the safety switch.

16. The squeeze-type juice extractor according to claim 1, wherein the drive member comprises a motor and a reduction mechanism connected to the motor, the reduction mechanism is connected to the drive shaft, and the drive shaft and the drive member are disposed eccentrically.

17. The squeeze-type juice extractor according to claim 16, wherein an installation support for installing electric components is disposed below the drive shaft.

18. The squeeze-type juice extractor according to claim 16, wherein a positioning groove is disposed at the bottom of the base, and the drive member is installed in the positioning groove.

19. The squeeze-type juice extractor according to claim 16, wherein a fixing stand for fixing the drive shaft is disposed at the top of the base, and a plurality of fixing columns is disposed inside the base.

20. The squeeze-type juice extractor according to claim 1, wherein the top of the base has a slope, and the squeeze assembly is installed on the slope in a tilted manner.

21. The squeeze-type juice extractor according to claim 1, wherein the feed assembly comprises a cover body locked on the squeeze assembly, a feed passage connected to the cover body, and a material squeezing rod, a convex portion is disposed on the cover body, a bearing is disposed in the convex portion, and the bearing is connected to a top of a transmission shaft of the screw rod.

22. The squeeze-type juice extractor according to claim 1, further comprising a residue glass and a juice glass, wherein the residue glass fits with the residue discharge passage, the juice glass fits with the juice outlet, and both left and right corners of the juice glass are disposed with a spout.
